(19) United States
(12) Patent Application Publication
(10) Pub. No.: US 2026/0076401 A1
(43) Pub. Date: Mar. 19, 2026

(54) Method for Automated Extraction of pulp, juice and other products from an encapsulated fruit, produce, or seed

(71) Applicant: Vebu Inc., Gerdena, CA (US)

(72) Inventors: Arthur Francois David Levy, Los Angeles, CA (US); Siddhant Shivaram, Los Angeles, CA (US); Aaron Lucas, Sherman Oaks, CA (US); Vahid Alizadehyazdi, Long Beach, CA (US); Michael Charles Lui, Cerritos, CA (US)

(21) Appl. No.: 19/325,307

(22) Filed: Sep. 10, 2025

Related U.S. Application Data
(60) Provisional application No. 63/694,723, filed on Sep. 13, 2024.
(60) Provisional application No. 63/694,716, filed on Sep. 13, 2024.
(60) Provisional application No. 63/694,293, filed on Sep. 13, 2024.

(51) Int. Cl. A23N 7/08; A23L 19/00

(52) U.S. Cl. CPC A23N 7/08; A23L 19/03

(57) ABSTRACT

An automated fruit processing system for cutting the fruit in half, removing the core, and extracting the flesh from the peel includes a plurality of functional assemblies arranged within an enclosure. Exemplary stations include a clamping module, rotating module, and cutting module. A computer and electronics are programmed and operable to control the automated stations. Related methods are described.

### CROSS-REFERENCE TO RELATED APPLICATIONS

This application claims priority to provisional application No. 63/694,723, filed Sep. 13, 2024, entitled “AUTOMATED PRODUCE DE-SEEDING AND PULP EXTRACTION MACHINE”; provisional application No. 63/694,716, filed Sep. 13, 2024, entitled “Method for Automated Extraction of pulp, juice and other products from an encapsulated fruit, produce, or seed”; and provisional application No. 63/694,293, filed Sep. 13, 2024, entitled “Method and system for singulating and dispensing an object, fruit or produce”, each of which is incorporated by reference in its entirety for all purposes.

### BACKGROUND OF THE INVENTION

### 1. Field of the Invention

This invention relates to food processing systems, and more particularly, to automated food processing systems adapted to automatically split, core, and extract the pulp from fruit.

### 2. Description of Related Art

In the restaurant environment, various desirable food items such as guacamole are prepared using fresh avocados. The avocados are cut in halves and the pit is removed (hereinafter sometimes referred to as “depitting” or “coring”) by hand. The process relies entirely on employee labor. In addition to being slow, tedious, and prone to injury, the amount and quality of the fruit obtained by the manual process is inconsistent. These shortcomings are exasperated when there is a need to rush or for a large quantity.

Additionally, extracting the usable flesh of the produce from the internal cores/seeds is a labor-intensive process. Flesh yield is often compromised due to the difficulty of the adherence of the flesh to the seed and the rush for deliverables arising in commercial settings.

Some industrial systems exist for extracting flesh, pulp or juices. These existing systems, however, tend to be too large and can require extensive post-processing of the extracted product to render it food safe. Extensive post-processing is required in the case of industrial avocado flesh extraction methods which allow contact between the extracted flesh and the outer layer of the fruit thus introducing pathogens into the flesh. These processes therefore must rely on high pressure processing to sanitize the flesh and render it safe for consumption. These methods are impossible to recreate in a commercial kitchen environment due to the required size and cost of the equipment involved.

In order to automate the processing of fresh produce in a commercial kitchen setting, a system is necessary to receive, sort and store the output of the automated processing system. The system must be compact enough to fit within a commercial kitchen while also being able to sort waste products (e.g., the peels) from the edible yield (e.g., the extracted produce flesh).

While some foods can be prepared in advance for an expected rush, there is still a need for fresh preparation of certain food items such as fresh avocado and guacamole. To store avocado and guacamole after they have been prepared reduces the quality of the appearance and taste to some extent. This is undesirable.

There is therefore a need for an improved avocado splitting, coring and pulp extracting system, and particularly, one that is automated and can quickly process multiple avocados for use in the restaurant environment and without requiring additional sanitizing of the extracted product.

### SUMMARY OF THE INVENTION

An automated method for extraction of pulp, juice and other valuable products from an encapsulated fruit, produce, or seed includes a plurality of functional assemblies arranged within an enclosure.

In embodiments of the invention, an automated produce splitting, coring and pulp extraction system comprises: a clamping assembly comprising opposing jaws to hold and squeeze the produce; a cutting assembly to cut the produce into parts while the produce is held in the clamping assembly; a rotary module to move the clamp sets, and a food collection and holding station to collect edible parts from nonedible parts of the produce.

The description, objects and advantages of the present invention will become apparent from the detailed description to follow, together with the accompanying drawings.

### BRIEF DESCRIPTION OF THE DRAWINGS

FIG. 1 is a right-side isometric view of an automated fruit processing system shown in an open configuration in accordance with an embodiment of the invention;

FIG. 2 is a front view of the automated fruit processing system shown in FIG. 1;

FIG. 3 is an exploded diagram of the automated fruit processing system shown in FIGS. 1-2;

FIG. 4 is a flow chart of a method for processing a fruit in accordance with an embodiment of the invention;

FIGS. 5-6 sequentially illustrate cooperating assemblies for clamping an object in accordance with an embodiment of the invention;

FIGS. 7-8 sequentially illustrate cutting the object into halves in accordance with an embodiment of the invention;

FIGS. 9-10 sequentially illustrate rotating the clamp assemblies outwards for deseeding the produce in accordance with an embodiment of the invention;

FIGS. 11-12 sequentially illustrate coring an avocado half in accordance with an embodiment of the invention;

FIG. 13 illustrates the processing system in a pulp ejection configuration in accordance with an embodiment of the invention;

FIGS. 14A-14C sequentially illustrate shimmying or scraping the pulp of an avocado half in accordance with an embodiment of the invention;

FIG. 15 is a block diagram of an automated produce or fruit processing system in accordance with an embodiment of the invention;

FIG. 16 is a schematic diagram of a clamping, cutting and peeling module in accordance with an embodiment of the invention;

FIG. 17 is a software architecture diagram of an avocado processing system in accordance with an embodiment of the invention; and

FIGS. 18A-18B show enlarged perspective views of the right top and right bottom clamps, respectively, in accordance with an embodiment of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

### Apparatus Overview

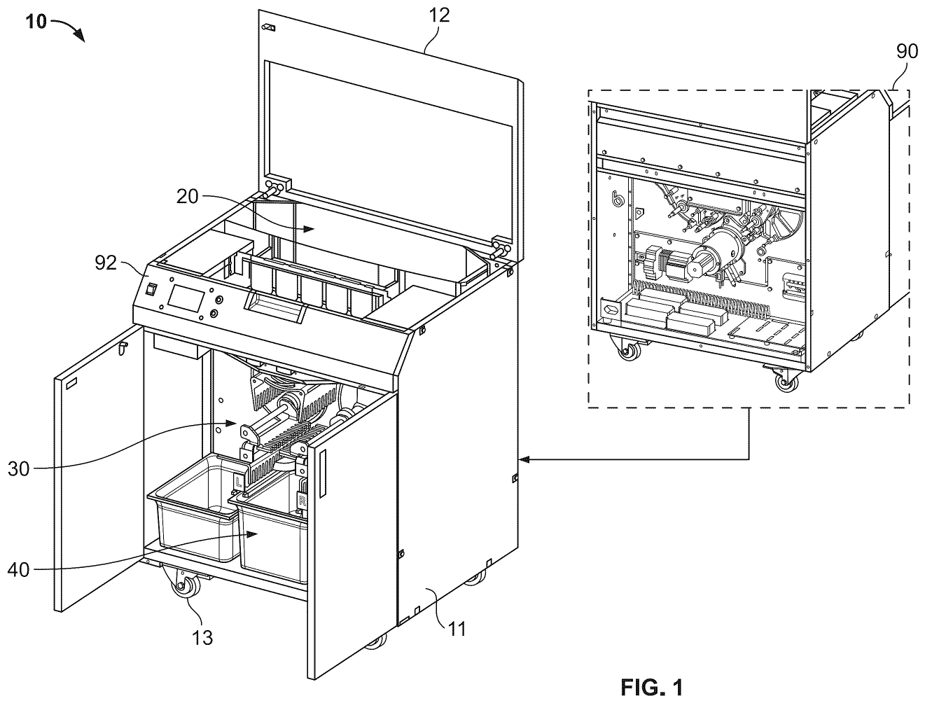

FIG. 1 shows an automated avocado processing system 10 in accordance with an embodiment of the invention. The system 10 has an enclosure or frame 11 including a hinged lid 12 shown in the open configuration. When the lid 12 is closed, the lid can serve as a work surface. Caster wheels 13 are arranged on the feet of the frame to conveniently roll the entire system.

The system 10 is shown having a loading station 20, a cutting, coring and peeling (sometimes referred to herein as a “C2P”) station 30, a food and waste storage station 40, and a computer and electronics enclosure or chamber 90, each of which is discussed herein.

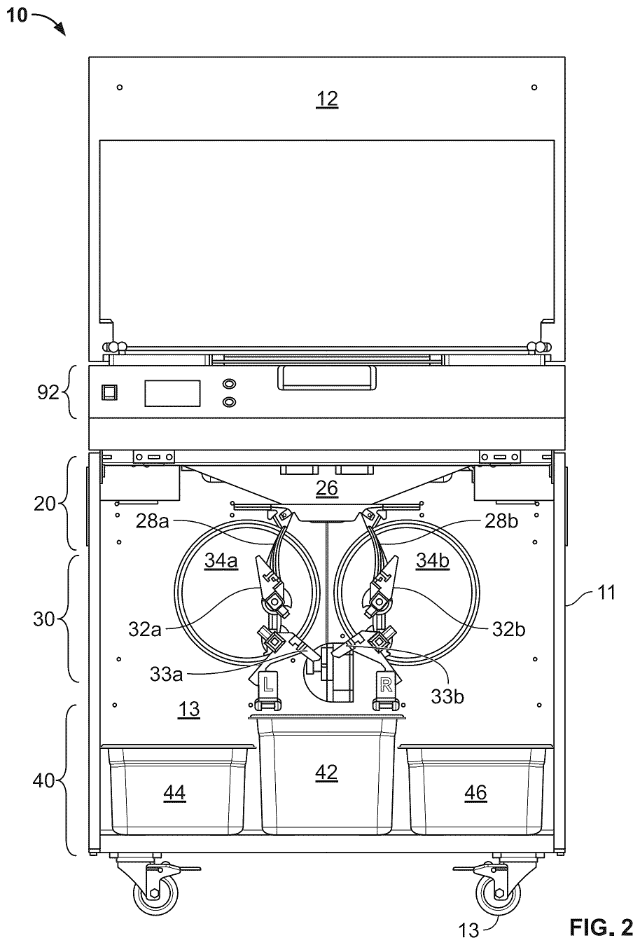

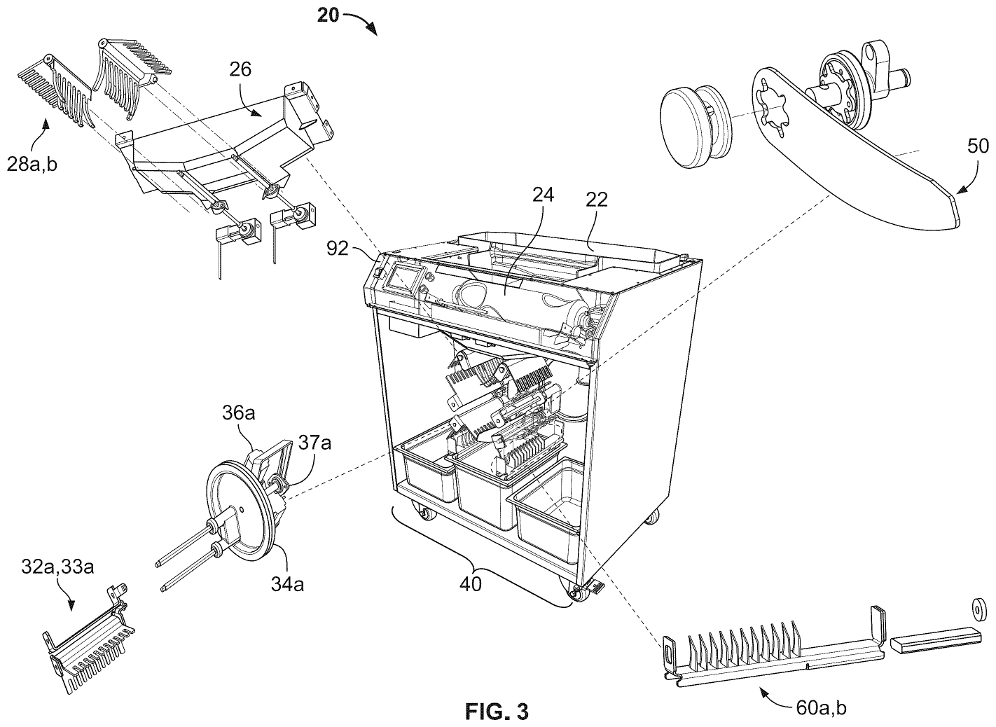

FIGS. 2-3 show the relative internal arrangement of the components of each of the stations.

For embodiments, the loading assembly 20 includes a hopper bin 22, singulation drum 24, funnel 26, and trap doors 28a, 28b arranged below the funnel to receive the produce, often an avocado. The hopper bin feeds the produce into a rotating drum 24. An example of a hopper system for singulating a produce is described in provisional application No. 63/694,293, filed Sep. 13, 2024, entitled “Method and system for singulating and dispensing an object, fruit or produce”, which is herein incorporated by reference in its entirety for all purposes.

The cutting coring and peeling assembly 30 includes clamps arranged side by side in a mirrored fashion. Each of the left and right-side clamp sets contains an upper jaw 32a, 32b and lower jaw 33a, 33b vertically spaced from the upper jaw. The jaws are operable to move relative to one another for clamping onto the produce.

In embodiments, each clamp set is driven by a rotator actuator operable to rotate the clamp set independently around a set rotation point via the rotators 34a, 34b. Additionally, all jaws are driven independently by a jaw actuation system (e.g., left jaw actuators 36a, 37a) capable of rotating both clockwise and counterclockwise. Optionally, as discussed herein, the jaw actuators are configured with a compliant feature which can compress by a small amount of rotation in one direction.

For embodiments, when a certain clamp jaw rotates in one direction (e.g., counter-clockwise), it is fully coupled to the clamp driving actuator and can apply the full torque of the actuator to any object it contacts. And when the jaw rotates in the other direction (e.g., clockwise), it is coupled to the clamp driving actuator through a compliant system, described herein, which must first be fully compressed before the torque of the actuator can be applied to the object the jaw contacts. In particular embodiments, the top left 32a and bottom right 33b jaws are spring loaded when rotating clockwise while the top right 32b and bottom left 33a jaws are spring loaded when rotating counterclockwise. This compliant system offers multiple advantages: it allows for repeatable control of the torque applied to a fruit by the clamps when they first come in contact therefore controlling the risk of inadvertently tearing or bursting the fruit; it provides a method of keeping pressure on the fruit with the clamps throughout the processing cycle, even with fruits which might plastically deform during the process; and it provides feedback when the jaw makes contact with the fruit by comparing the difference between the angular position of the jaw and the angular position of the jaw actuator. These advantages serve to adapt the system to process fruits of varying sizes, shapes, softness and rebound characteristics.

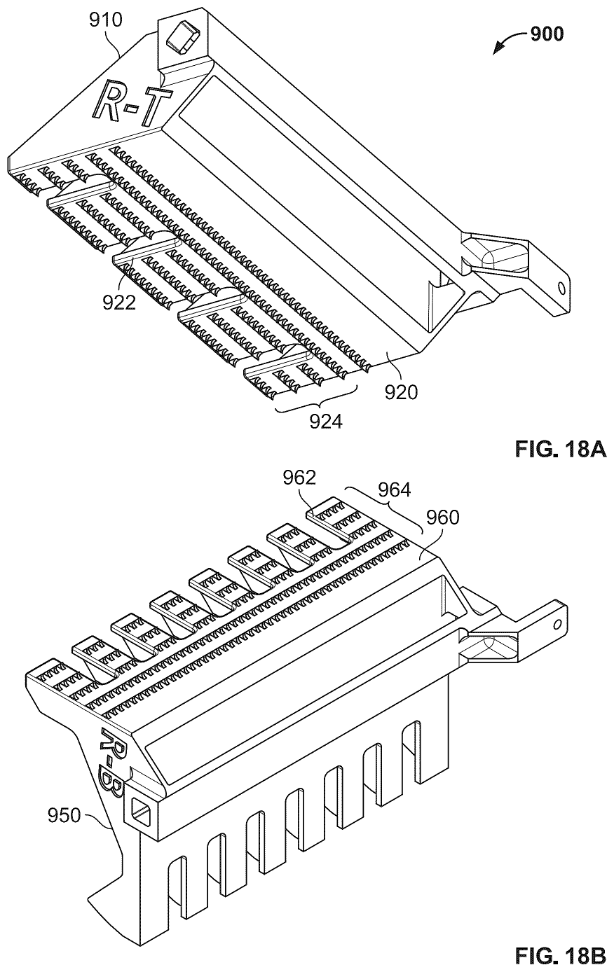

In embodiments, the jaws are made of a rigid material and, with reference to FIGS. 18A-18B, can include a pattern of teeth 924, 964 on the face 920, 960 to contact the fruit. The pattern is optimized to increase grip on the surface of the fruit.

In embodiments, the jaws may be made wholly or partially from a flexible material to increase the contact area with the fruit and lower the risk of bruising its skin.

In embodiments, the clamps are designed to be removable for cleaning. Each jaw may be arranged on a shaft and held in place by a pin, clip or locking lug.

In embodiments, a cutting system is located between the left and right clamps and consists of a removable cutting device 50 and a cutting actuation system. This system drives the blade 50 through the fruit, cutting it into 2 parts including the core or seed. Optionally the actuation system can be augmented to add an oscillating motion to saw through hard-to-cut cores. Alternatively, an impact drive mechanism can be used to aid in fracturing the hard-to-cut cores.

A core ejecting system 60a, 60b comprises two ejector arrays designed to make the coring process independent of the fruit's position on the clamps. Each array consists of small blades optimized to cut through the side of halved fruits and eject any whole or half pits, depending on the cutting mechanism used. During operation as discussed herein, the rotators 34a, 34b rotate the staged clamped halves of fruits through the coring arrays 60a, 60b. Cut outs on the face of clamps (e.g., 962 of R-B jaw 950 shown in FIG. 18B) allow the small blades of the coring arrays to cut through the skin of the fruit and eject the seed parts.

A food and waste holding assembly 40 includes a centrally located waste bin 42 arranged directly below the blade 50, and a flesh bin 44, 46 on each side of the waste bin for receiving the ejected pulp from the separated avocado halves as described further herein. In embodiments, the waste bin is a ½ size standard hotel pan, 8″ deep. In embodiments, the waste bins are ½ size standard hotel pan, 6″ deep.

The computer and electronics 90 are arranged in the rear of the enclosure and separated from the other stations that directly process the avocados by a panel or wall 13. In embodiments, a rear panel to the enclosure 11 is removable to provide convenient access to the computer and electronics.

In embodiments, the computer and electronics 90 include a custom PCB board, multi-axis controller, power supplies, power inlet plug, and actuator drivers.

A control panel or dashboard 92 is also shown on the top of the body 11 including a power switch, emergency stop and various other buttons, lights, indicators, gauges operable with the computer and electronics 90 for controlling operations of the system as described further herein.

Preferably the system is configured to operate on a standard wall outlet plug.

The frame or enclosure 11 is designed to house the above described sub-systems. Embodiments include a number of features including four caster wheels mounted to the bottom of the frame to enhance mobility of the apparatus in the kitchen; a flat top surface for use as a table top for food preparation and/or storage while the apparatus is operating as well as dormant; a top lid to open up and access the feed area to load the machine with a case of avocados; a double door in the front for easy access to the coring cutting and peeling station and the food and waste storage station; a wall for separating the food area from the electronics for ease of cleaning and safety of electronics against food particles, water, cleaning solutions, etc.; and a small footprint under 30″ W×24″ D×34″ H, allowing the system to be able to easily fit in a multitude of kitchen spaces.

### Method for Cutting, Coring and Peeling a Produce

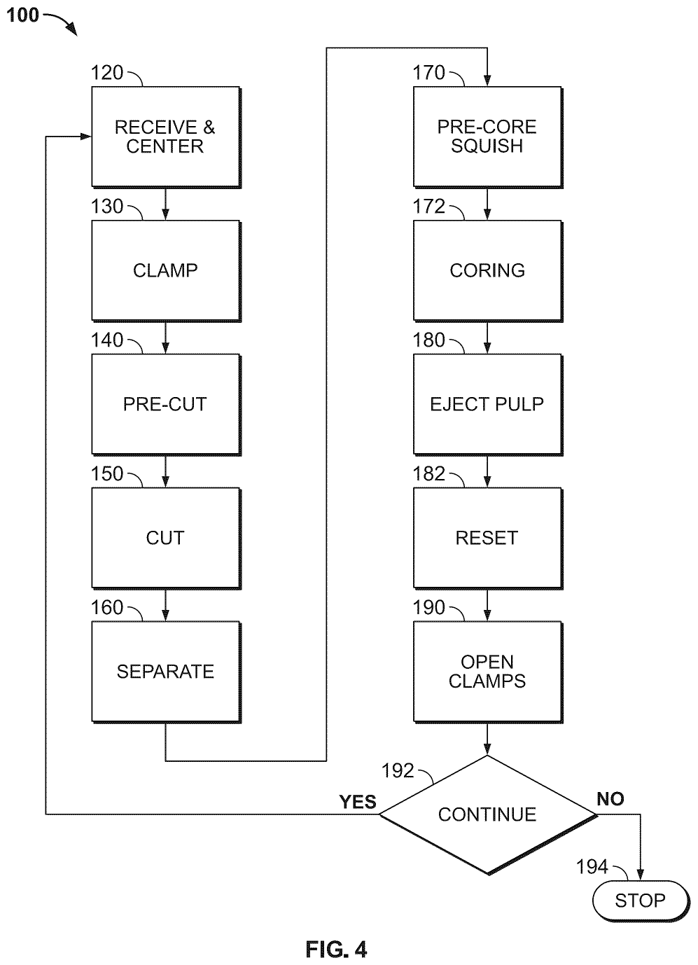

With reference to FIG. 4, an exemplary process 100 for cutting, coring and peeling a fruit is illustrated. In describing the process 100, reference is also made to FIGS. 1-3, 5-14 for showing various exemplary structures to perform each of the steps of the process.

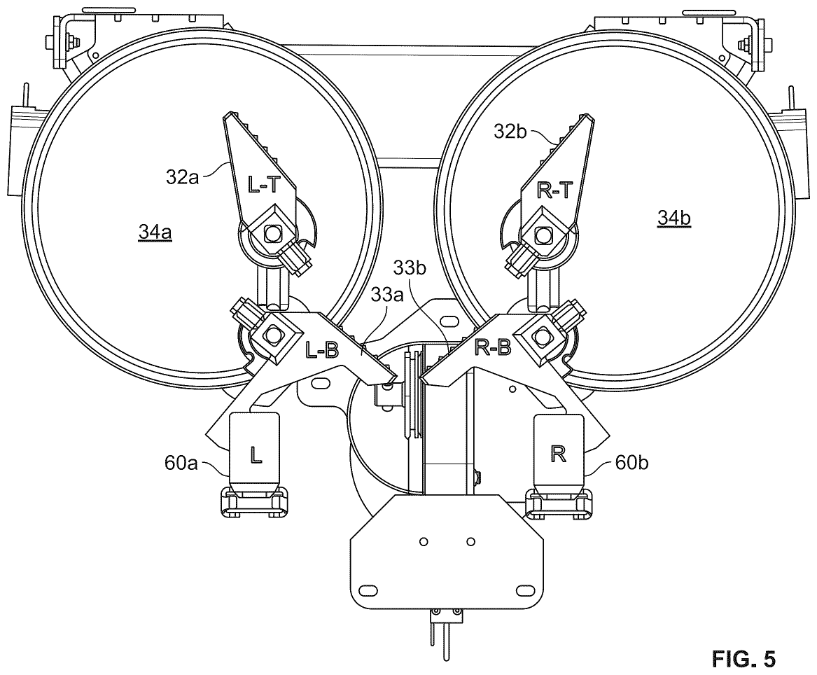

Step 120 states to receive and center. With reference to FIG. 5, the bottom jaws (LB 33a, RB 33b) are arranged to form a catch position—optionally forming a V-shape—and the top jaws (LT 32a, RT 32b) are rotated away from the bottom jaws. The blade (not shown) is also rotated into a vertical position, away from the bottom jaws. In this state a fruit can be fed into the catch position formed by the bottom jaws. The catch position jaw arrangement provides a stable resting position for the fruit and centers the fruit between the 2 sets of jaws regardless of the size and shape of the fruit. The catch position arrangement shown in FIG. 5 is especially effective to center ovoid or ellipsoid-shaped objects. This ability to center the fruit regardless of the size and shape of the object enables the system to process a wide range of fruits.

In embodiments, once the fruit has been received the bottom jaws alternate rotating up to a horizontal position then back down to the catch position. This action helps align the fruit with its major axis along the cutting plane and center the fruit in between both sets of jaws.

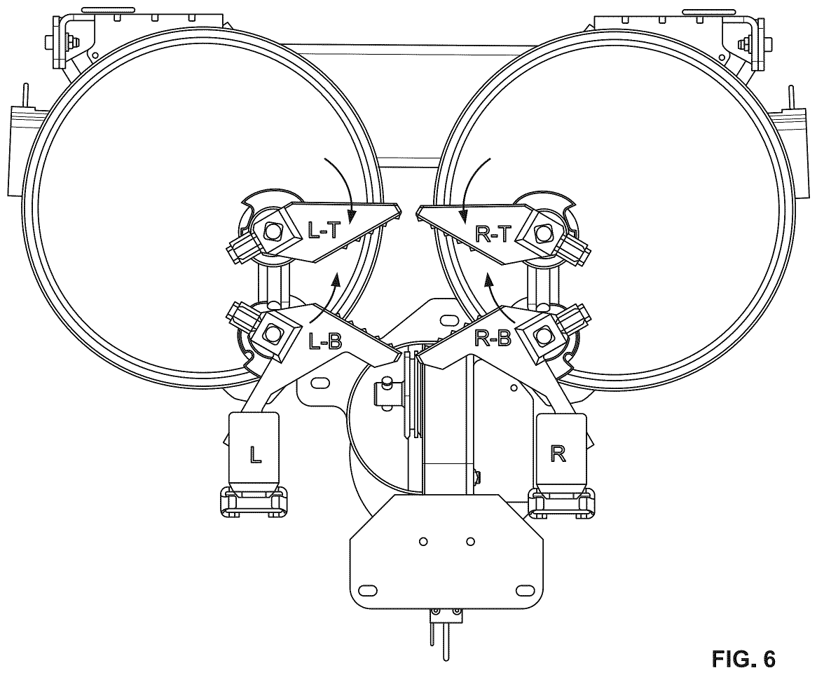

Step 130 states to clamp. With reference to FIG. 6, the top jaws (LT, RT) are rotated to mirror the position of the bottom jaws (LB, RB). This step ensures the fruit is centered in between the top and bottom jaws which allows for deterministic positioning of the core in the fruit. Then, the jaws are closed together at the same rate. That is, the LT jaw rotates towards the LB jaw and the RT jaw rotates towards the RB jaw.

As the top jaws of each clamp set make contact with the fruit (not shown), a spring-loaded system of each clamp actuator starts to compress until the angular difference between the deflected jaw and its driving actuator has reached a threshold angle. In embodiments, the threshold angle ranges from 5-30 degrees, and in preferred embodiments, ranges from 5-15 degrees, and is optionally about 10 degrees.

The compliance system may vary. In embodiments, the compliance system is spring-based including a spring or other type of resilient member operable to apply a force when compressed or deflected. It can be embedded in the gear drive itself or another location along the drive shaft mechanism.

At this point the spring-loaded system of each clamp is fully compressed and the fruit is retained by all 4 jaws—each applying a full spring load. In embodiments, the spring load or force ranges from 0.3 to 2 Nm.

Additionally, in embodiments, jaw deviation data or sensor feedback is generated and recorded based on the spring-loaded mechanism between the jaw's actuator and the shaft. The sensor can monitor the displacement of the jaw relative to the actuator (e.g., LT jaw 32a to actuator 36a as shown in FIG. 3). When the jaw is driven into the fruit by the actuator it will at first be stopped in its motion by the fruit while the actuator continues turning until there is no more compliance left between the actuator and the jaw. The sensor detects the amount the actuator has continued moving while the jaw was stationary. The computer is pre-loaded with the designed amount of compliance such that when the sensor reads the difference in motion between jaw and actuator to be the designed amount of compliance, the system determines that the fruit is present and is securely held by the jaws. An example of a type of sensor is an encoder such as CUI Devices'AMT103.

In embodiments, the presence of an avocado can be confirmed based on the sensor feedback. In embodiments, the size of the avocado can be computed based on the sensor feedback. In embodiments, the hardness or ripeness of the fruit can be computed based on the sensor feedback. In embodiments, the sensor signal is calibrated with small, medium, large and extra-large avocados to be able to classify the size of the fruit. In embodiments, the sensor signal is calibrated with ripe and unripe avocados to be able to classify whether the fruit is ripe. In embodiments, the system includes a predetermined database or lookup table for a variety of types of fruits or produce, classes for size and ripeness, and the corresponding sensor data ranges. When sensor data is detected, the system can immediately provide the size and ripeness for the produce.

In preferred embodiments, due to the mirrored nature of the motion of all 4 jaws, the fruit is centered between all 4 jaws serving to allow the system to process many sizes and types of fruits because the fruit is cut in roughly equal parts and locates the pit of the fruit along a known axis, parallel and equidistant to the rotation axes of all 4 clamps.

Step 140 states pre-cut. This step serves to increase retention on the fruit. The jaws are further driven into the fruit. In embodiments, the amount of rotation or displacement of the jaws is based on the estimated size of the fruit from step 130. By evaluating the size of the fruit as determined by the compliant sensor system described herein, a desired retention adjustment is computed. For example, the jaws shall not be rotated to the same angular position for a small fruit as they would for a large fruit. To rotate the same angular position would crush the small fruit.

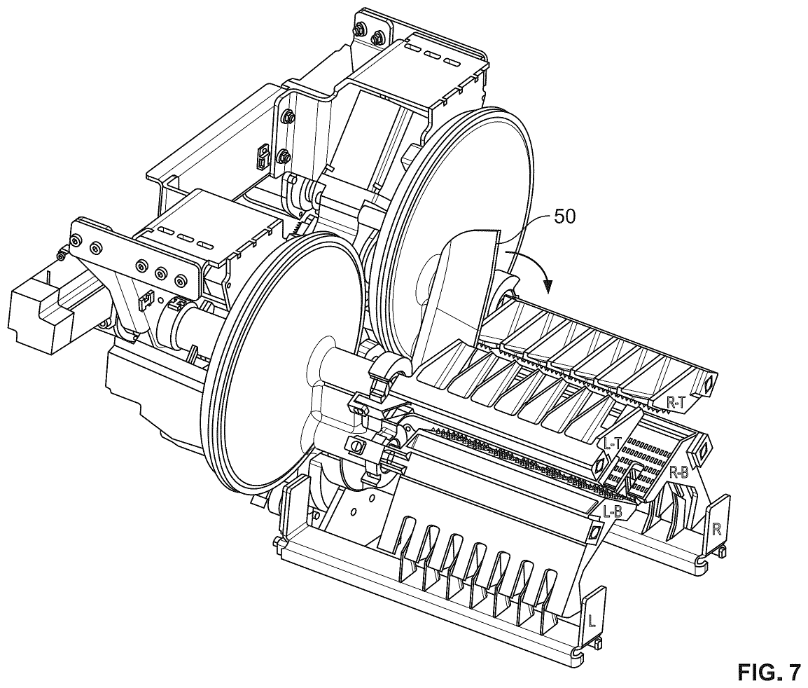

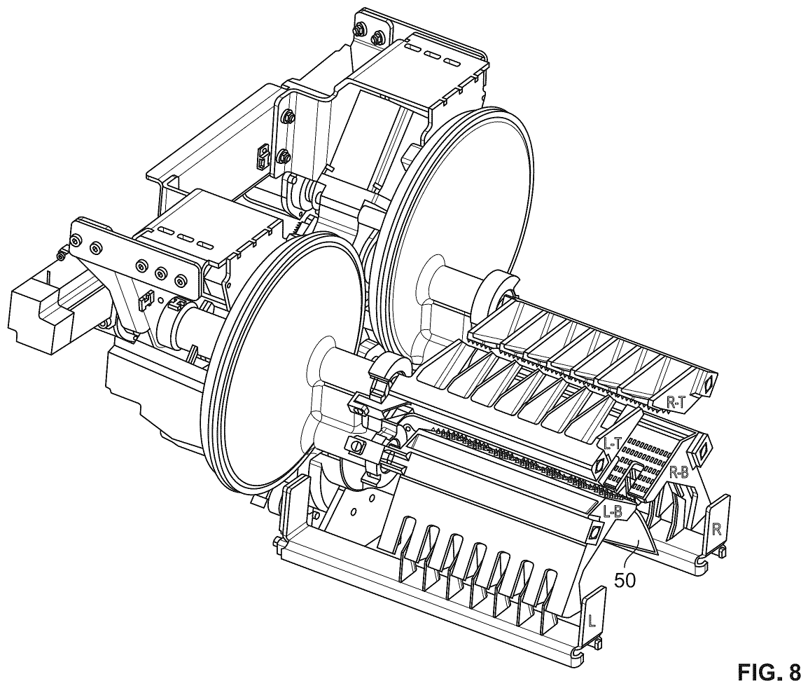

Step 150 states cut. With reference to FIGS. 7-8, this step is performed by rotating the blade 50 downward to cut fully through the fruit and seed/pit if present.

Step 160 states to separate. In embodiments, each set of clamps is rotated away from each other by its rotator by a set amount sized to create enough spacing between both fruit halves to allow for the largest possible seed half to fall out.

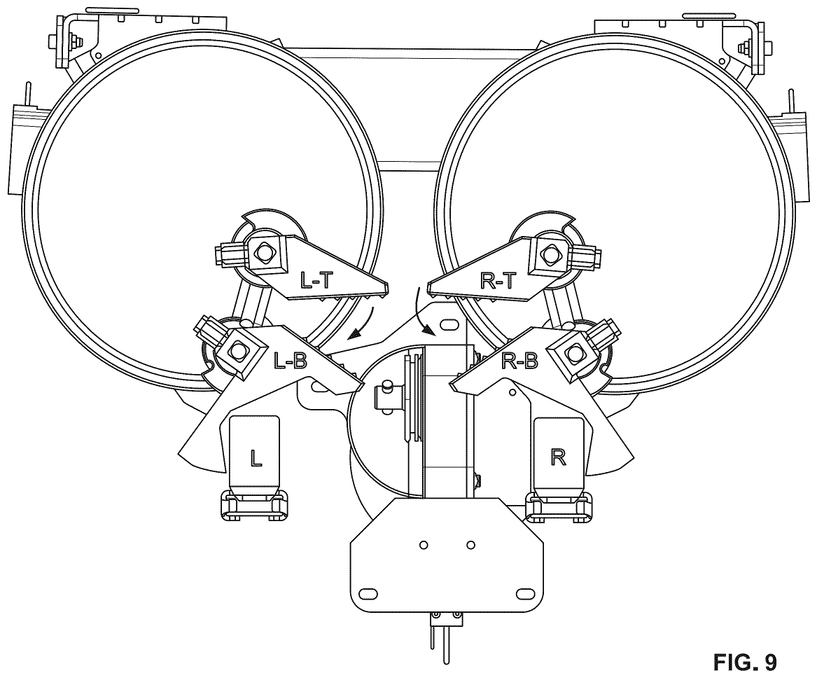

Step 170 states to pre-core squish. With reference to FIG. 9, the clamps are further driven into the fruit by an amount proportional to the estimated size of the fruit. This step both increases the grip of the clamps onto the halved fruit but also loosens the seed halves of the fruits to aid in coring. In certain fruits this step is enough to eject the seed halves.

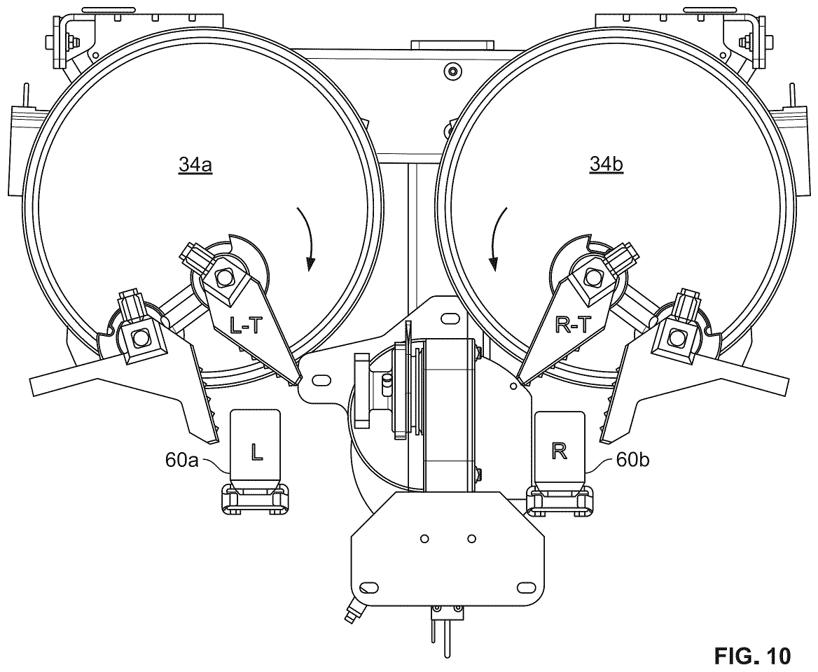

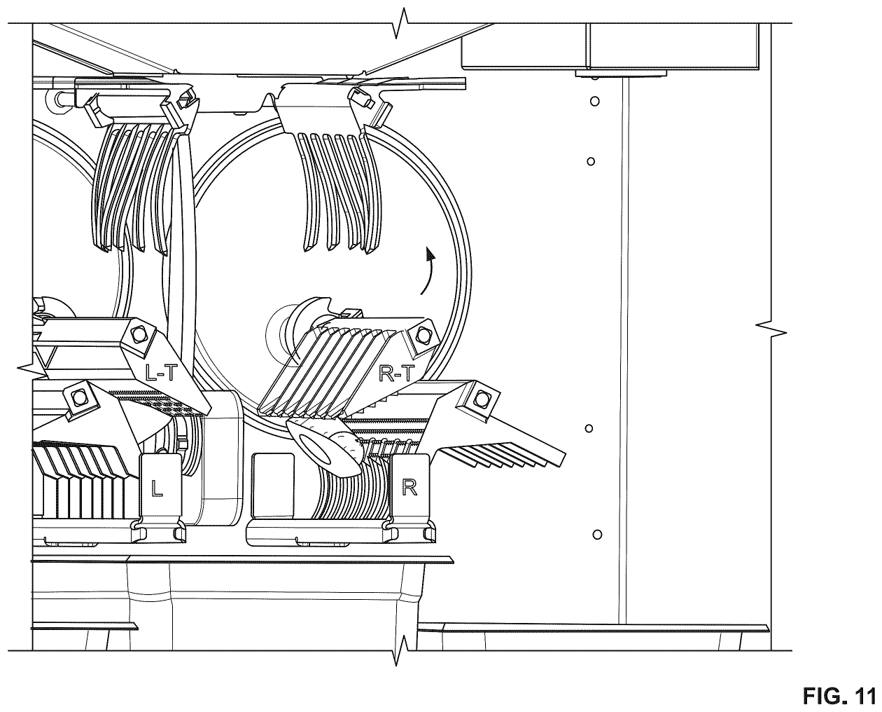

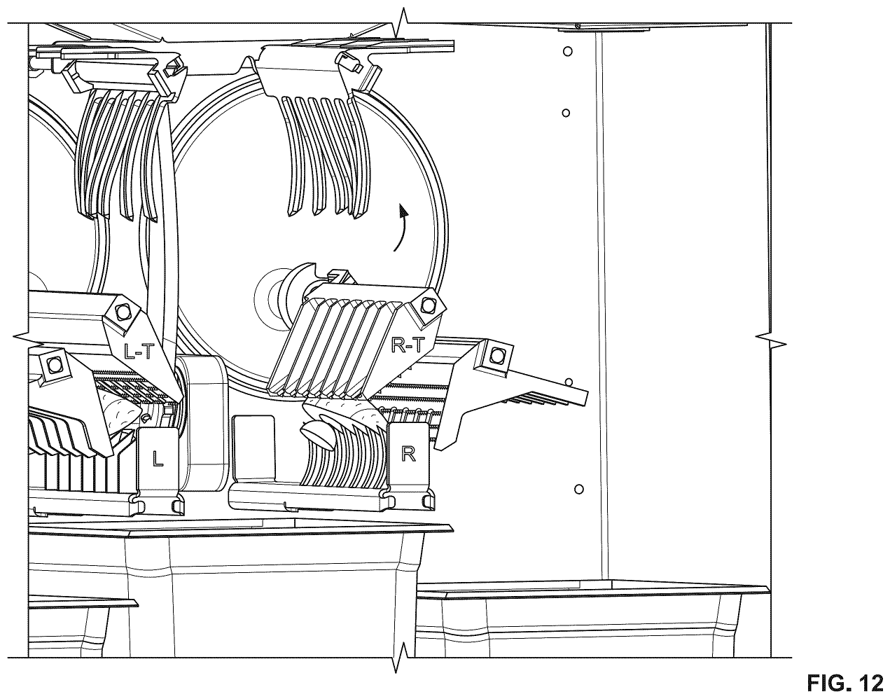

Step 172 states coring. With reference to FIG. 10, both rotators 34a, 34b rotate the clamp sets outwardly such that the staged fruit half is swiped across the coring array 60a, 60b. The blades of the coring arrays, being arranged to contact with the seed due to the centering of the fruit described above, enter the fruit half from the uncut side through the cutouts in the lower jaw, make contact, and eject the seed parts as shown sequentially in FIGS. 11-12.

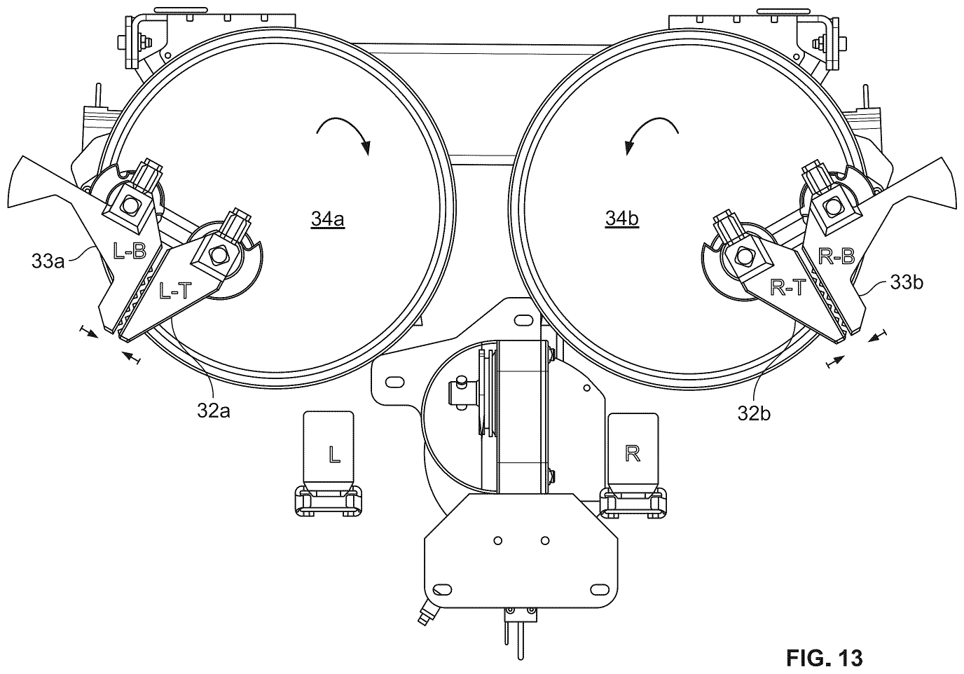

Step 180 states eject pulp. In embodiments, and with reference to FIG. 13, the opposing jaws, namely, left side opposing jaws L-T (32a) to L-B (33a) and right side opposing jaws R-T (32b) to R-B (32b) are closed, thus squeezing the fruit half therebetween and expelling the edible flesh and juice into food collection bins (not shown) arranged below the jaws.

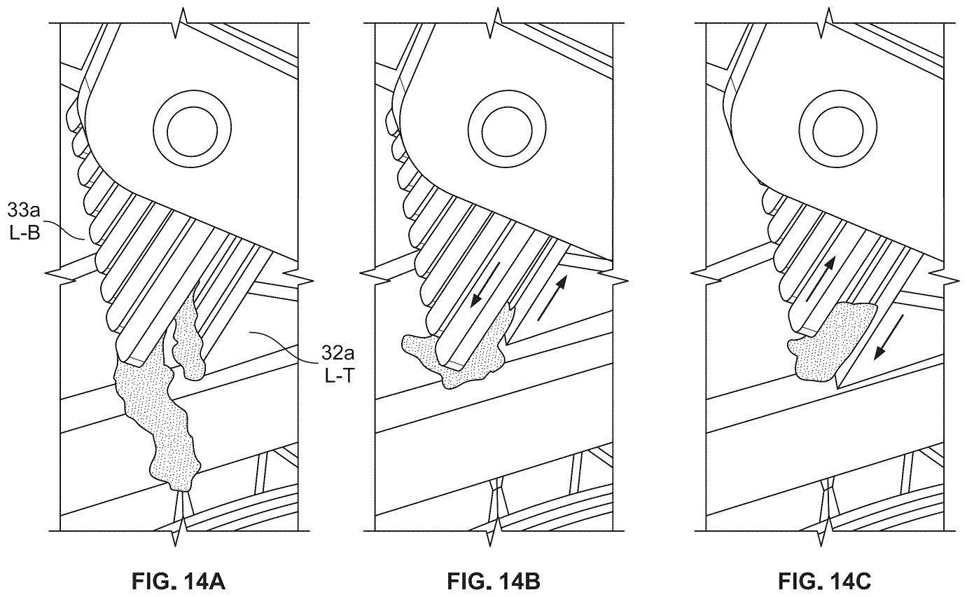

With reference to FIGS. 14A-14C, opposing jaws (e.g., 33a, 33a) can be optionally further manipulated back and forth relative to one another causing a scraping or shimmying action serving to increase yield beyond the initial pulp squeeze.

Step 182 states to reset. The rotators move the clamp sets into their original positions above the waste bins, and the knife is rotated back into its original position.

Step 190 states to open jaws. Opposing jaws (e.g., 33a, 33a) are rotated away from one another into their original position, thus releasing the inedible fruit peels into waste bins.

Step 192 states to continue. This step queries for whether a process command has been received. If ‘yes’, the method proceeds to step 120 to repeat the process from the beginning on a new fruit. If not, the method is halted 194, and optionally, an operator is alerted via the dashboard 92 or otherwise to check or power off the system.

### Computer and Electronics

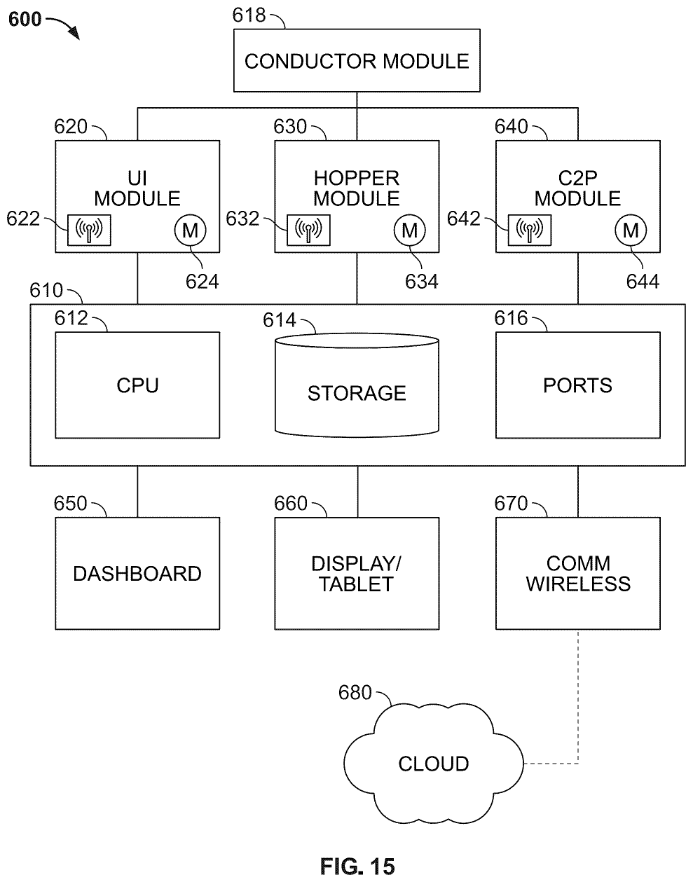

FIG. 15 is a block diagram of an avocado processing system 600 in accordance with embodiments of the invention. The system 600 is shown including a computer 610, conductor module 618, UI module 620, hopper module 630, C2P module 640, and dashboard 650.

Computer 610 is shown including a processor 612, storage 614, and ports 616 (or pins in the case of the micro-controller or PLC) for connecting with various different types of peripherals, devices and/or power. The computer may include one or more processors or a processor framework. The processor is programmed and operable to carry out the steps described herein based on firmware and software (including the various modules) stored in the computer.

In the system 600 shown in FIG. 15, each of UI module 620, hopper module 630, and C2P module 640 can include one or more dedicated sensors 622, 632, 642 and optionally motors 624, 634, and 644. The modules are operable to communicate and share information with the computer 610 including keeping track of the state of the motors and components as described herein.

Power supplies, converters, and other electronic components can be present for carrying out the steps described herein. Some components can be dedicated to one action or module, and other components can be shared. For example, the computer may include a DC power supply to drive each of the motors of the modules. Alternatively, each module may have a dedicated power supply. Indeed, the invention may include a wide range of electronic and mechanical (including pneumatic) configurations.

Optionally, the system 600 may include a display 660 such as monitor or a touchscreen tablet.

Optionally, the system may include a wireless communication board or module 670 for communicating with mobile devices, local networks, and/or remote servers or cloud servers 680.

Although a dashboard was described above including various buttons and switches, embodiments of the invention can include a screen and optionally, a touchscreen, to control the system. A computer may be programmed and operable to show or indicate (e.g., via animation) the status of the process. The computer can be programmed and operable to keep statistics of the number avocados processed, namely, split and cored, or otherwise processed as described herein. In embodiments, a scale may be incorporated into the system to measure the weight of the fruits in the bin over time. In other embodiments, motions, timing and metrics can be controlled and detected using computer vision. Each of the assemblies may be controlled by standalone electronics or by a main computer or processor programmed and operable to carry out the functions described herein including conveying, singulating, staging, orienting, cutting, coring, peeling, and food and waste collection.

Additionally, the system may be programmed and operable for integrated data tracking for metrics including flesh yield, total avocados processed (optionally by size), cycle time, unripe avocado count and food safety or expiration. For example, the processor may be programmed to compute the above metrics based on sensor data for time elapsed, mass, volume, and avocado count.

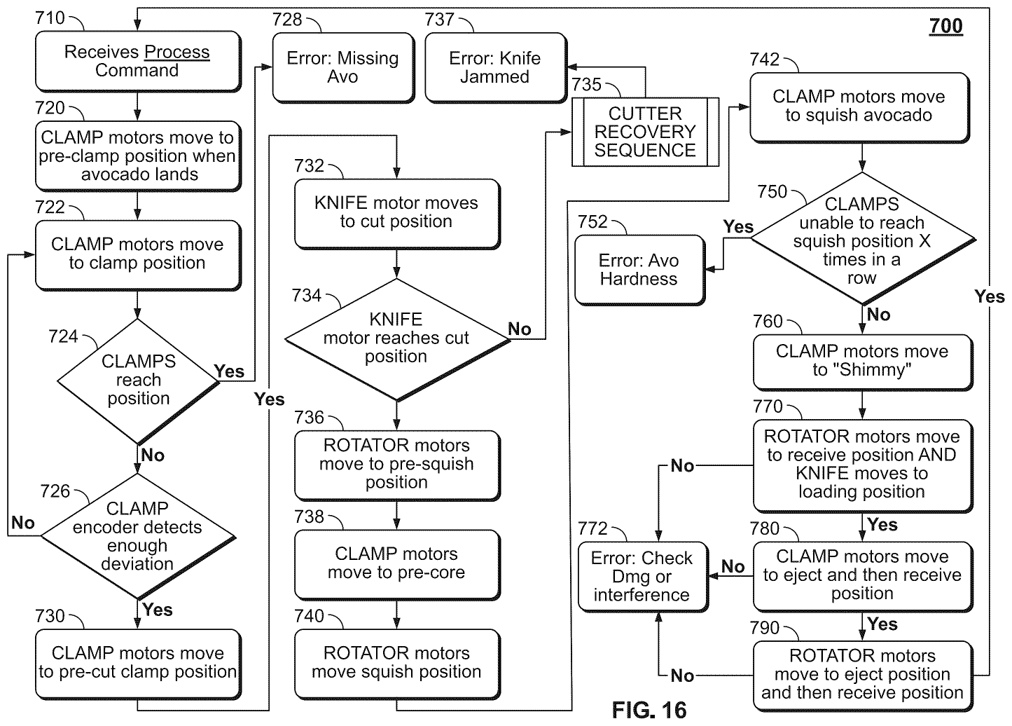

FIG. 16 is a schematic diagram of a cutting coring and peeling (C2P) process 700 in accordance with an embodiment of the invention.

Step 710 states receive process command. This is an instruction to start the process. It can be based on manual input from a user, triggered by a sensor when an object passes into the C2P processing area, or triggered by a time delay from the completion of a loading function in an upstream system, such as the opening of trapdoors 28a/b.

Step 720 states clamp motors move to pre-clamp position when the object lands. The jaw actuators rotate the top jaws of each clamp towards the corresponding lower jaws by a pre-set angle which allows for some space between the upper jaws and the object. In embodiments, this angle ranges from 20 to 45 degrees such that a gap of 10 to 50 mm between the object and upper jaws exists.

Step 722 states clamp motors move to clamp position. This step is performed by the jaw actuators of each clamp rotating the jaws towards the object as described above in step 130.

Step 724 queries for whether the jaws reach the empty clamp position. This step queries for whether the jaws reach a preset or predefined angle associated with the object being missing. In embodiments, the predetermined angle is 0 degrees from horizontal. If the jaws reach the empty clamp position, an error message is generated according to step 728.

However, if an object is indeed present, the process moves to step 726 which states to detect enough deviation via the clamp encoder. This step is performed as described above using a compliant or spring-loaded mechanism coupled to the jaw actuator. When the actuator rotates the jaw into contact with the object, the jaw actuator continues to rotate while the spring-loaded mechanism deflects until a threshold force is reached at which time the actuator is stopped. The encoder detects the deviation in angle/location from the when the jaw first contacts the object to when the actuator is halted. This angle is stored and may be used for determining characteristics of the object or operating parameters as described herein (e.g., ripeness, size, amount of clamping to be applied in subsequent steps, etc.)

If the deviation is insufficient (e.g., if the difference between the angle of the clamp jaw to angle of the jaw motor's shaft is insufficient) the process 722 continues and the jaws continue to be driven inwards. This sub-loop is repeated until the amount of deviation is sufficient at which point the method proceeds to step 730, or the clamps reach the final position without sufficient encoder deviation. If the clamps reach the final position without sufficient encoder deviation, then an error is triggered that represents no avocado in the clamps.

Step 730 states to move the motors to pre-cut position. This step is performed by the jaws moving further together to increase the gripping force on the object. In embodiments, the jaws are moved together another 1 to 10 degrees. In embodiments, this step can include computing a pre-cut position based on the feedback data from step 726.

Step 732 states knife motor moves to cut position.

Step 734 states knife motor reaches cut position. This step is performed using the motor sensor to confirm whether the knife has been actuated properly. If not, the process moves to steps 735/737 to return knife to home position and generate an error code reflecting the knife has not been deployed.

If the knife reaches the cut position, the process moves to step 736.

Step 736 states to move the rotors to pre-squish position. This step is performed by moving the rotors as shown FIG. 9 to locate the object halves above the waste bin.

Step 738 states clamp (namely, jaw) motors move to pre-core. This step is performed as described above in connection with step 170 of FIG. 4 in which the jaws are moved towards one another to loosen the core from the object, and in some cases, eject the core from the object. In embodiments, this step can include computing a pre-core position based on the feedback data from step 726.

Step 740 states rotator motors move to squish position. With reference to FIGS. 10-12, this step is performed by moving the rotators 34a, 34b across the coring arrays 60a, 60b, into the squish arrangement in which each clamp is located over an edible food bin (not shown).

Step 742 states clamp motors move to squash avocado. This step is shown in FIG. 13 in which opposing top and lower jaws are shown in a closed or clamped configuration.

Step 750 queries for the whether the jaws reach a squash position after a threshold number of attempts (e.g., 3-5 attempts). The motors are controlled to apply a pre-set torque to the jaws. In embodiments, the pre-set torque ranges from 15 to 30 Nm. If the jaws do not reach the squash position, an error is generated according to step 752. Failure to reach the squash position in view of the pre-set torque is indicative of a hard object, and in the case of a fruit, could be indicative of the fruit being unripe. In embodiments, a lookup table is stored corresponding to the degree of ripeness versus compression torque per produce.

Step 760 states clamp motors move to ‘shimmy’. With reference to FIGS. 14A-14C, this step is performed after the produce has been squashed as described above, and by moving opposing jaws in opposite directions to one another. The opposing jaw motion scrapes any pulp remnants from the skin and into the waste bins arranged below the jaws.

Step 770 states rotator motors move to receive position and knife moves to loading position as shown, e.g., in FIG. 7.

Step 780 states clamp motors move to eject and then receive position as shown, e.g., in FIG. 5.

Step 790 states rotator motors move to eject and then receive position. As the rotator motors move outwards during this step, the lower clamp is moved across the coring array to remove any skin remaining on the lower clamp as described above. Then, the rotator motors return the jaws to the home or receive position.

If there are no errors during steps 770-790, the method returns to step 710 and the entire process is repeated for cutting coring and peeling another produce.

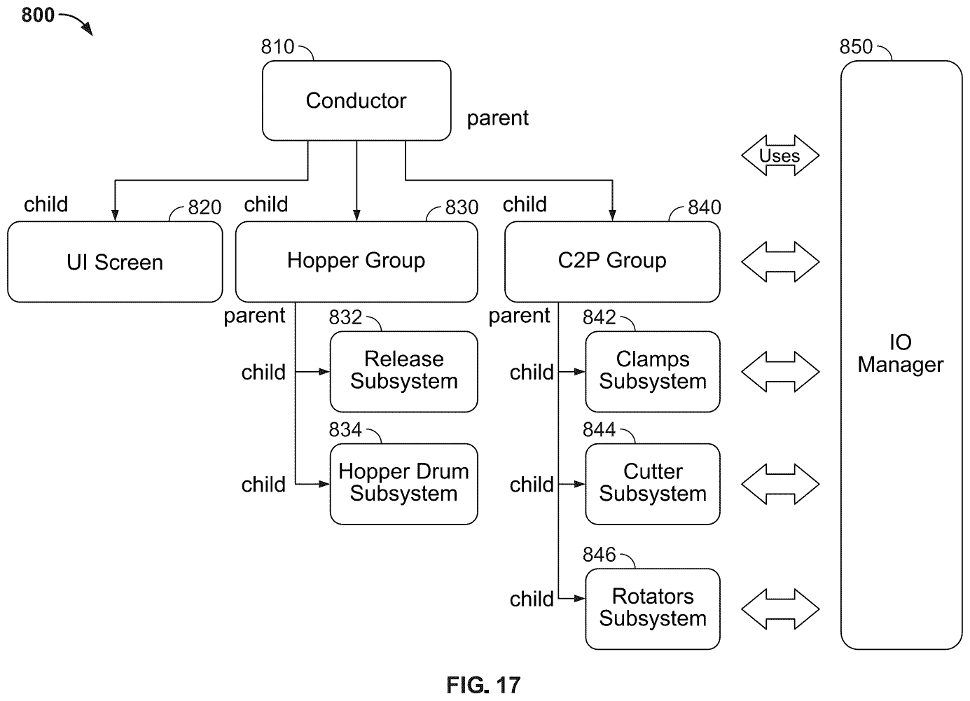

FIG. 17 is a software architecture diagram of an avocado processing system 800 in accordance with an embodiment of the invention.

The system 800 shows a conductor module for managing the submodules UI screen 820, hopper group 830, C2P group 840 and IO manager 850.

The hopper group 830 is further shown having a hopper drum subsystem 834 and release (namely, trapdoor release) subsystem 832, as described herein to control motors associated with each subsystem.

The C2P group 840 is further shown having a clamp subsystem 842, a cutter subsystem 844, and a rotator subsystem 846 as described herein to control motors associated with each subsystem.

The IO manager 850 is operable to, amongst other things, manage data from sensors and motors in order for the subsystems to perform their tasks as described herein.

In embodiments, mechanical sensors are located at the ‘home’ location for the clamps, rotators, and trapdoor systems. They are used as a positive homing confirmation.

In embodiments, encoders are on the output shafts of the clamps and rotators. These sensors are able to report the location of the clamp and rotators. This information is used to determine whether there is an avocado clamped, the hardness of the avocado, and whether there are any obstructions in the movement path.

In embodiments, induction sensors are used in the cutter system and two of them are placed in the loaded and fully unloaded positions. They are used to determine the state of the cutter and whether it is stuck or free to move.

In embodiments, motor torque sensors are used to provide feedback to the motor driver about the motor's movement and ‘effort’. This sensor feedback is used to ‘home’ the systems to a hardstop, check clamp installation, and estimate actuator health.

Indeed, a wide range of sensor types can be used to trigger stages, monitor system progress and health, and compute metrics.

### Alternative Embodiments

While the current system describes a pair of clamps, other configurations may be used depending on the produce being processed. For example, a single clamp set could be used to position a fruit in the path of the cutting system such that a small cut may be made on the outer shell of the fruit. Then the jaws of the clamp may squeeze any useful juices or flesh from the fruit out of the small cut.

In embodiments, more than two clamps can be used in a similar fashion as described in the two clamp embodiment by simply replicating the described system circularly around the fruit being processed.

In embodiments the compliant mechanism may be excluded. The system can be specifically tailored to processing a single type of fruit or a single size and ripeness or class of fruits of similar sizes and ripeness.

In embodiments, a torque-controlled servo motor is used instead or in addition to the compliant or spring-loaded feedback system described above.

In embodiments, clamp sets are driven in a linear motion (with linear actuators or a piston for example) or along an arc with a linkage mechanism or any combination of those methods instead of being driven in a rotational motion.

In embodiments, the clamps are a composite and include a rigid body and an elastic face (e.g., silicon rubber). That elastic face conforms to the fruit to augment the grip of the clamp as well as more evenly distribute the pressure when squeezing to increase the yield.

In embodiments, the face of the clamps comprises ridges or spikes instead of teeth.

In embodiments, the face of the clamps comprises a low grit texture instead of teeth

In embodiments the faces of the clamp jaws may be slightly bowed towards each other and each jaw may be constructed to have stiff compliance. When forced against each other such jaws first make contact at a point closest to each other's center of rotation. As the opposing jaws are further forced closer together each jaws'compliance allows the point of contact to move away from the center of the jaws'rotation. This ensures that when the clamp closes on a halved fruit or produce item a high pressure pinch point is created at the back of the item and moved into the item urging the flesh, pulp or juice out of the item with concentrated force.

In embodiments, instead of a single clamp, the clamp may be sectioned with each section having compliance to the driving actuator of the clamp and, thus, providing parallel processing of multiple products or varying shapes at the same time.

In embodiments, between the left and right clamps, a cutting system is equipped with a spring-loaded removable blade and a linear/rotation actuation mechanism. This setup enables back-and-forth/rotation movement of the blade, facilitating the cutting motion required for operations. In embodiments, the system works by translating the blade into the fruit and letting the resistance from the pit deflect the blade rotationally until the pit is passed. This cuts around the pit of the fruit without affecting the pit itself.

In embodiments, between the left and right clamps, a robust, high-strength spring-loaded chopping system has a removable blade and release mechanism. This setup enables the blade to rotate rapidly, generating the chopping motion required for operations. This system is designed to cut through the pit of the fruit as part of its functionality.

In embodiments, between the left and right clamps, a cutting assembly includes a wire cutting mechanism. This system enables the flexible deflecting wire to rotate and cut through the fruit, following the surface of the pit, without cutting through the pit.

In embodiments, between the left and right clamps, a core ejecting system comprises two ejector arrays designed to make the coring process independent of the fruit's position on the clamps. Each array consists of small sticks optimized to cut through the back of halved fruits and eject any whole or half pits, depending on the cutting mechanism used. In an embodiment, each clamp set is equipped with a linear mechanism that moves the staged clamped halves of fruits to the coring stick arrays. In this implementation, there is no need for cutouts on the jaws.

In embodiments, the coring arrays are independently actuated to generate any path through the halved avocado to dislodge the core. The actuation may be a simple rotation or translation or a more complex motion as could be generated by an n-bar linkage.

In embodiments, the knife includes wedge-shaped sharp features on both sides. The features are arranged to match the cutouts on the jaws, serving to push out half of the pits during the cutting step.

The hardware and electronics may vary.

Examples of types of sensors include, without limitation, proximity sensors, time of flight sensors, ultrasonic sensors, retro-reflective sensors & photoelectric sensors.

Examples of types of actuators include without limitation stepper motors and servomotors.

Optionally, in lieu of sensors, other mechanisms (mechanical-based) can be arranged along the route to singulate an avocado including, e.g., levers or switches along the route that are triggered when an avocado passes. The levers and switches may be designed to cause the motors to start and stop. Indeed, a wide range of trigger arrangements to control dispensing and singulation of an avocado are intended to be included within the scope of the invention.

In embodiments of the invention, the system can include additional sensors and/or vision directed at the various handoff points between stages to qualify and/or quantify attributes of the objects of interest (namely, the produce). In embodiments, qualifying the object can include, but is not limited to detecting whether the object is damaged or bruised; what is the ripeness or visible exterior of the object; and what is the orientation. In embodiments, quantifying the object can include, but is not limited to detecting the weight and dimensions of the object. Visions systems can include, e.g., camera(s) and a processor programmed with trained detection and classification models to perform the functions described herein.

In embodiments of the invention, various hardware components of the system are tracked. In one embodiment, an RFID tag is arranged on the component to be tracked. Examples of hardware components to be tracked include, without limitation, consumables such as the clamping jaws and cutting blades.

In embodiments of the invention, the system has pre-established quantified datasets for the average mechanical decay rate of each consumable or component to be tracked. As the system operates, the runtime and maturity of the components are tracked using, e.g., a unique ID sensed by the RFID receiver for each component.

In embodiments of the invention, the metrics and data tracking the system records are integrated with a wide range of food service and restaurant data applications. In embodiments of the invention, the metrics and data tracking the system records are integrated with a food service, restaurant or a commissary, or a processing plant. The metrics are uploaded to the databases, providing real time data to help monitor efficiency of operations within the kitchens.

In embodiments of the invention, the system contains additional food safety capabilities such as and not limited to UV sanitizing lamps and heated surfaces to remove pathogens on the produce it processes as well as to prevent growth of pathogens within the machine

In embodiments of the invention, the system contains cooled compartments for the storage of raw produce and useful yield, thus increasing the duration of safe storage within the machine.

Still other modifications and variations can be made to the disclosed embodiments without departing from the subject invention. For example, the avocado processing system may have more or less functional stations and components than that shown and described herein. The system may also be modified to accommodate other food objects and produce and preferably, other pitted foods such as plums, peaches, mangoes, papayas, etc. Additionally, although reference was generally made herein to cutting the avocado into equal halves, it is to be understood that the invention may be directed to cutting the avocado into two parts that are not equal in size. One half may be slightly larger than the other half.

1. An automated produce splitting, coring and pulp extraction system comprises:
a clamping assembly to hold a produce;
a cutting assembly to cut the produce into parts while the produce is held in the clamping assembly; and
a food collection and holding station to collect edible parts from nonedible parts of the produce.

2. The system of claim 1, wherein the clamping assembly comprises a left side and a right side, and wherein each of the left side and right side comprises a bottom jaw and a top jaw.

3. The system of claim 2, wherein the jaws of the left and right side clamping assemblies are operable to collectively form a processing area for the produce to fall onto, and optionally wherein the processing area has a V-shape profile.

4. The system of claim 3, wherein the motion of the jaws is at least partially symmetric top to bottom and left to right such that the produce is centered during clamping.

5. The system of claim 4, wherein the clamping assembly is operable to detect the size of the produce during clamping.

6. The system of claim 4, wherein the cutting assembly further comprises a blade.

7. The system of claim 6, further comprising a rotator actuator operable to separate the first half and second half of the produce after it is cut.

8. The system of claim 7, wherein each upper and lower jaws of each side are operable to squish the produce half to a degree to at least loosen, if not eject, the core mass from the produce half.

9. The system of claim 8, wherein in the clamping assembly is configured and operable to apply an amount of compression based on the size detected during clamping.

10. The system of claim 9, wherein each of the left side clamp and right side clamp are operable to move the produce half through a core extractor.

11. The system of claim 10, wherein the core extractor is an array of blades or projections meant to contactor the core and push it out of the produce half.

12. The system of claim 10, wherein each of the left side and right side clamps are operable to squish the pulp from the produce half and into the collection bin.

13. The system of claim 4, further comprising a compliance system in mechanical cooperation with one the jaws and operable to compress or deflect as the produce is clamped.

14. The system of claim 1, further comprising a tracker arranged on a consumable component, optionally, wherein the tracker is arranged on a cutting blade or a clamp jaw.

15. The system of claim 1, further comprising a dashboard comprising a plurality of user input features (e.g., levers, knobs, buttons, etc.) and indicators (LEDS) to control actions (e.g., power, start stop, speed, produce size, etc.) and show the status (e.g., on/off, status machine) of the system.

16. The system of claim 1, further comprising a computing device, power supply, and a plurality of sensors programmed and operable to control the loading, cutting and food collection and holding assemblies, and optionally, wherein the computing device is selected from a computer, PLC and micro-controller.

17. A method for automatically processing produce having a pit or seed, the method comprising:
clamping the produce;
splitting the produce into halves;
coring the produce to remove the pit or seed from the halves; and
ejecting the pulp from the halves.

18. The method of claim 17, further comprising classifying the size of the produce.

19. The method of claim 18, further comprising adjusting the clamping based on the size of the produce as determined by the classifying step.

20. The method of claim 19, wherein the produce is avocado.
